(19) United States
(12) Patent Application Publication
(10) Pub. No.: US 2008/0154395 A1
(43) Pub. Date: Jun. 26, 2008

(54) Device

(75) Inventors: Goran Henriksson, Eksjo (SE); Jan-Erik Steen, Vallentuna (SE)

Correspondence Address: DICKSTEIN SHAPIRO LLP, 1825 EYE STREET NW, Washington, DC, 20006-5403, US

(73) Assignee: OLSBERGS HYDRAULICS AB, Eksjo (SE)

(21) Appl. No.: 11/663,843

(22) PCT Filed: Sep. 27, 2005
(86) PCT No.: PCT/SE05/01417

§ 371 Date: Mar. 27, 2007

(30) Foreign Application Priority Data
Sep. 28, 2004 (SE) 0402351-1

(51) Int. Cl. G05B 15/00; G06F 3/048

(52) U.S. Cl. 700/83; 715/772

(57) ABSTRACT

The present invention relates to an actuator (2) for controlling and observing functions of a machine, comprising two or more hand-operated control members (3-8), functional display elements connected to each control member. Each of said hand-operated control members (3-8) are arranged to control one or more functions included in different functional groups (16-20). Said functional display elements comprising one or more electro-optical displays (12, 13) divided into one or more display sections (24-29), whereby each display section is connected to a certain control member and has a specific logical positions in relation to this control member, and is arranged to show the function that is controlled by this controlled by this control member (3-8) and also to show information about the status of functions of the machine. The present invention also relates to a computer program product to am actuator according to the present invention. An operator can control the crane on a distance away from the lorry, by using the remote control unit such as a portable remote control unit.

### TECHNICAL FIELD

The present invention relates to an actuator for two-way communication, such as control and supervision of machine functions, e.g. the function of a hydraulic unit. The present invention also relates to a computer program product provided with a programming code comprising control commands for an actuator according to this invention.

### BACKGROUND

A portable actuator is normally used for controlling the functions of a machine, such as a hydraulic lorry mobile crane. Presently, these actuators are normally radio-controlled, enabling the operator of e.g. a lorry mobile crane to control and supervise the various operations of the crane from a desired distance and to move freely thereabout. However, the actuator may still be remotely controlled via a cable. In order to control a specific operation of a hydraulic crane, the operator activates a control member of the actuator. The control member is variably operated, and arranged to be spring-loaded in order to return to a neutral starting position when it is not activated. The remote/radio control is performed by the actuator via an electrical control system regulating an electrical switch attached to the direction vent of the hydraulic system in order to regulate the flow of the hydraulic fluid to the working cylinder of the machine/crane according to the control performed via the control member of the actuators. The control rate of a specific function via a control member is directly proportional to the displacement of the control member from its neutral starting point.

For safety reasons it is vital that the operator is alerted by a monitoring system of the control system of a risk of overload during controlling and lifting of objects with the crane. It is also important that the operator is informed of the current load, the length of a projecting part, etc. of a specific crane element, etc. A previously known actuator has two-way communication between the operator and the crane, comprising a display/screen showing the current load, pressure and the current projecting length of the crane element. It is also known to provide an actuator with light emitting diodes alerting at overload and light emitting diodes adapted to indicate other information.

One drawback with conventional actuators is that the increasing number of functions to be controlled and supervised is becoming increasingly complex and difficult to grasp for the operator. Today, an actuator is capable of controlling up to twenty, or even more, different crane functions. Since the number of control members on a portable actuator is limited to no more than approximately eight, due to practical reasons and to be manageable, each control member has to be arranged to be able to control more than one function. According to the security rules of the European Machine Directive and of the specific crane regulations, it must be clear which function/s/that is/are controlled by each control member. Obviously, it is difficult for the operator of an conventional actuator, as described above, to grasp which function that is activated, which continued events that is taking place during the control of a current function by means of a specific control member, and e.g. to comprehend the meaning of a lightning alert from a light emitting diode. In other words, the complicated design of the conventional actuator makes it unmanageable for the operator, and the security may be neglected. An attempt to solve the problem describe above involves marking each control member with signs/notes provided with symbols indicating the functions to be controlled by the control member. However, this will not solve the problems described above regarding the clearness and safety.

### DESCRIPTION OF THE INVENTION

It is an object of the present invention to provide an actuator that alleviates at least some of the drawbacks associated with the prior art devices, as described above. A further object is to provide an actuator enabling a simpler, clearer and more comfortable control of a specific function by an operator. A further object is to improve the security while performing work operations with an actuator. Additionally, one object is to provide a computer program product provided with a programming code comprising commands for an actuator according to the present invention.

These objects are achieved by an actuator for two-way communication, e.g. control and supervision of machine functions, according to the present invention, as defined in claim 1, comprising two or more manual control members for controlling various functions. A function displaying means is connected to each control member for indicating the selected function. Each manual control member is arranged to control one or more functions included in separate functional groups. Each functional group comprises no more than one function per control member, wherein a functional group is selectable by means of a functional group selecting means. Said functional group selecting means comprises one or more electro-optical displays/screens divided into one or more displaying sections, wherein each displaying section is connected to a specific control member and has a logical location relative this control member, and is arranged to display a symbol and/or a text indicating the function controlled by this control member, as well as display status information regarding machine functions recorded by the monitoring system of the machine when this control member performs control.

One advantage with the solution according to this invention is that it is easy to grasp and comfortable for the operator to be able to view a currently connected function of a specific control member directly on the actuator and to monitor the result when actuating the control member. The design according to the present invention further implies that an alert of the system, e.g. at an overload, immediately and clearly can be associated with the currently connected function of a specific control member, wherein the operator is able to rapidly perform an appropriate action. Thereby, the security is substantially improved in relation to any available and conventional actuator. An additional advantage with the present invention is that a logical location of the display section relative its connected control member eliminates the need of attaching notes or signs on each control member. A logical location implies e.g. that the displaying section for a specific control member is positioned substantially aligned with the forward and backward movement of said the control member.

According to a preferred embodiment, said manual control members are configured as a row of levers, arranged to be movable in a direction backwards and forwards in order to control a function. Electro-optical displays/screens are preferably arranged on a surface of an actuator, the surface positioned substantially in parallel with the row of control levers. Preferably, an actuator is provided with electro-optical display means for momentary or continuous display of a selected functional group.

The term electro-optical screen/display means in this specification refers to e.g. a LCD (Liquid Crystal Display)-screen, an LED (Light emitting Diode) screen, a plasma screen, or the like. Preferably, one or more of the electro-optical displays according to the present invention consists of a LCD-screen.

The present invention also relates to a computer program product provided with a programming code comprising commands for an actuator according to the present invention, as described above. The computer program product comprises information regarding the functions and of the corresponding control members of said functional groups, and is arranged to perform the following steps when executed on a computer: Receive a control signal associated with a selected functional group; collect information regarding the functions and the corresponding control members associated with the selected functional group, and to display these functions on the function displaying means in the displaying sections corresponding to each control member, respectively, according to the collected information.

Additional advantages and features according to embodiments of the invention will be apparent from the claims, as well as from the following description of the exemplary embodiments.

### DESCRIPTION OF THE FIGURES

The present invention will be described in detail in the exemplary embodiments, without limiting the scope of the invention, with reference to the appended drawings, of which:

FIG. 1A schematically shows a perspective view from above of en actuator according to the present invention,

FIG. 1B shows an explanatory front view of an actuator according to FIG. 1A,

FIG. 1C shows the electro-optical screen panel of an actuator according to FIG. 1A-B in an explanatory view, and exemplary symbols relating to a first functional group that may appear on the displaying sections located on the sides of the electro-optical screen,

FIG. 1D shows the electro-optical screen panel of an actuator according to FIG. 1A-B in an explanatory view, and examples of status information to be displayed on a central electro-optical screen, and

FIG. 1E shows the electro-optical screen panel of an actuator according to FIG. 1A-B in an explanatory view, and exemplary symbols relating to a second functional group that may appear on the displaying sections located on the sides of the electro-optical screen.

### DETAILED DESCRIPTION OF EXEMPLARY EMBODIMENTS

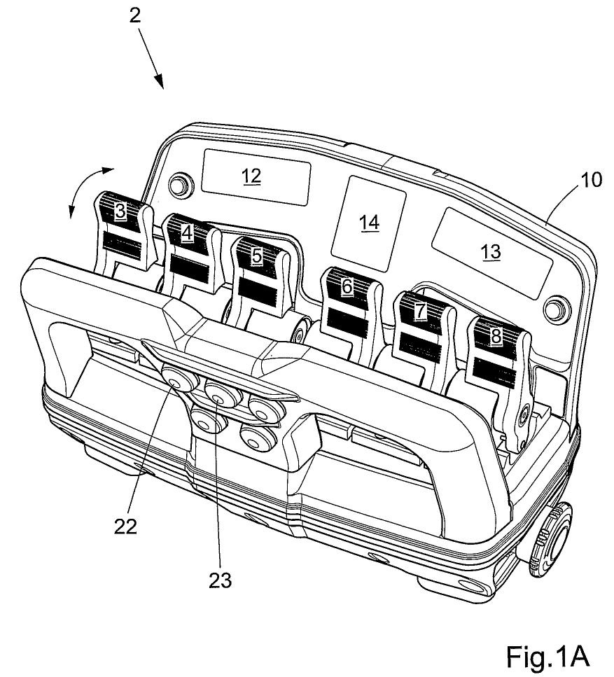

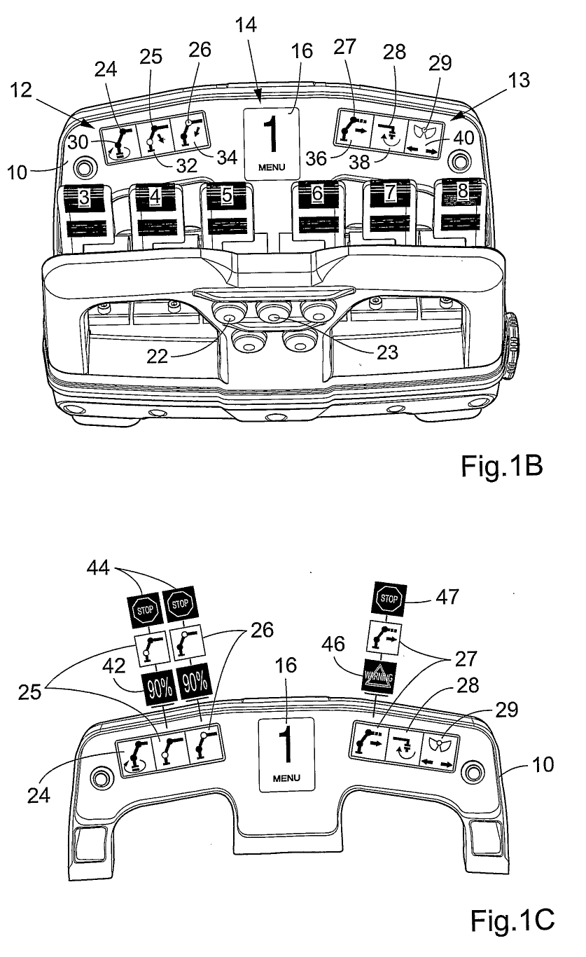

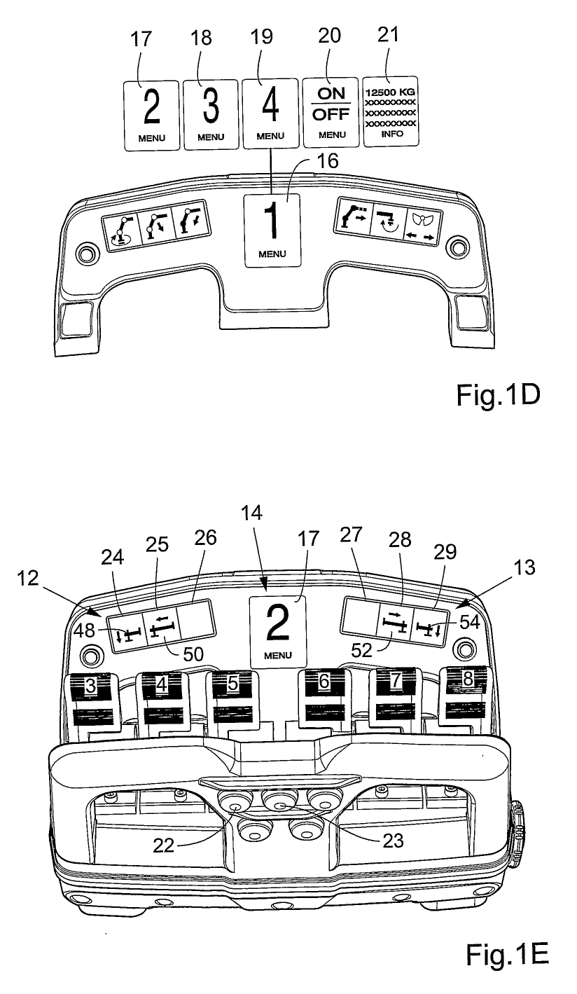

A portable actuator 2 for two-way communication, e.g. for the control and supervision of machine functions (not shown) is illustrated according to an embodiment of the invention in FIG. 1A-E. According to this embodiment, the functions of a hydraulic lorry mobile crane (not shown) is illustrated and described. An actuator according to this embodiment is adapted for two-way radio control. However, the actuator may alternatively be remotely controlled via a cable or a wire.

According to the embodiment shown in FIG. 1A-B, the actuator 2 comprises six manual control members 3-8, hereinafter referred to as levers, for the control of the different functions of the crane. Thus, the manual control members 3-8 are preferably designed as a row of levers, capable of forward and backward movement in one direction for the control of a function. Obviously, the control members may be of a different type or have a different design. Each control member 3-8 is electrically connected to a screen panel 10 for indicating a selected, active function. Three electro-optical screens are electrically connected to the control members, according to this embodiment, for momentary or continuous display, by means of symbols and/or text, of the status for a selected and active function, a first electro-optical screen 12, located to the left; a second electro-optical screen 13, located to the right, and a third, centrally located, electro-optical display means 14, which according to this embodiment is an electro-optical screen that is similar to the first and second electro-optical screens 12, 13. The electro-optical displaying means 14 is arranged to show the selected functional group, wherein some functional groups are adapted to different crane functions 16-19. Further, one functional group may consist of a functional state on-off 20 and another functional group may indicate status information 21, such as error code, alarm, or any other information, e.g. load and/or pressure (see also FIG. 1D, as described below). Obviously, an actuator 2 according to the invention may generally comprise only one large electro-optical screen located on the screen panel, but it may also be provided with more than the two electro-optical screens 12, 13 and the display means 14, respectively, as described and disclosed in FIG. 1A-E. The electro-optical screens 12, 13 and the display means 14 are disposed on a surface of the actuator, denoted electro-optical screen panel 10, and it is positioned substantially in parallel with the row of levers 3-8.

Each of said manual control members 3-8 is arranged to control one or more functions included in separate functional groups 16-20 (see e.g. FIG. 1D), explained in more detail below, and each one referred to as a “Menu”. As is apparent from FIG. 1B-C, the electro-optical screens 12-13 and the display means 14 indicate that the control members 3-8 of the actuator 2 is activated for a first functional group 16, Menu 1. Each functional group 16-20 comprises one function for each control member 3-8, wherein the desired functional group 16-20 is selectable by means of the functional group selecting means 22, which in the drawing is shown as an ordinary and easily accessible on/off-switch. Preferably, an easily accessible on/off-switch is arranged for a down-scaling functional state, “Micro” 23, achieving e.g. an action/speed at a maximum deflection of a control member that is only 30% of the ordinary full deflection, when the Micro-state is activated. The degree of down-scaling in percent, %, of the full deflection is preferably freely selectable. The disclosed first 12 and second 13 electro-optical screens, respectively, of the embodiment is divided into displaying sections 24-29 arranged for momentary or continuous display of the selected and active functions controlled by a specific control member 3-8 by means of symbols or text. Each displaying section 24-29 is clearly associated with a specific control member 3-8 by means of its position relative the control member, e.g. by being positioned substantially opposite said control member. As mentioned above, the function displaying means may, obviously, comprise one or more additional electro-optical screens, each one continuously displaying a selected and active function controlled by a specific control member.

According to the invention, each displaying section is connected to a specific control member and has a logical position relative this control member, which will be described in more detail in an exemplary embodiment with reference to FIG. 1B. Thereby, a specific control member may preferably be located substantially aligned with the forward and backward movement of the control members, which is shown in FIG. 1B. With reference to FIG. 1B, the displayed symbol on the left displaying section 24 in the first electro-optical screen 12, which is connected to a first control member 3, shows that the turning 30 of the crane around the horizontal plane is controlled according to a first functional group 16 by means of the first control member 3. The second control member 4, of the first functional group 16, controls the vertical movement of the crane in a lower part 32 of the crane, as displayed in the middle displaying section 25. The third control member 5 controls the vertical movement of the crane in an upper part 34 of the crane, as displayed in the right displaying section 26 of the first functional group 16. Further, the displacement in horizontal direction 36 of the crane is controlled by means of the fourth control member 6, which is displayed in the left displaying section 27 of the second electro-optical screen 13, controlled according to a first functional group 16. The fifth control member 7 controls the turning of an outer part 38 of the crane, which is displayed in the middle displaying section 28, and the sixth control member 8 controls the jaws of a bucket 40 arranged in an outer part of the crane, as displayed in the right displaying section 29 of the first functional group 16. The third central electro-optical displaying means according to FIG. 1B-C displays the current functional group, here “1 Menu”.

According to FIG. 1C, additional symbols/text is displayed in the displaying sections of the first 12 and second 13 electro-optical screens, respectively, in the functional groups 16-20, that may show various information from the monitoring system of the machine regarding the status of machine functions when a control member performs control. Thus, an alert of overload 49, “90%”, and a symbol indicating activation of an automatic stop 44, may be displayed, e.g. in the middle 25 displaying section and on the right 26 displaying section of the first electro-optical screen 12, in addition to the above-described symbols relating to different crane movements. An alerting symbol, formed e.g. as a warning triangle 46 and a stop 47 of the movement/function is displayed in the left displaying section 27 of the second electro-optical screen 13. Thus, any of the displaying sections 24-29, respectively, may be arranged to momentarily display information regarding the status of a machine function recorded by the monitoring system of the machine, if needed, instead of a displayed symbol/text relating to the function controlled by a specific control member. An example of the meaning of the latter will now be given with reference to FIG. 1B-C, in which the crane is displaced horizontally 36, according to a symbol in the left displaying section 27 of the second electro-optical screen 13, by means of the fourth control member 6 of the first functional group 16. If the horizontal 35 displacement of the crane exceeds a predetermined threshold value, the monitoring system of the crane will be activated and an alerting symbol in the form of a warning triangle 46 displayed momentarily in the displaying section 27, instead of the crane symbol 36. If the operator, notwithstanding, continues to displace the crane further horizontally in an incorrect direction, an additional predetermined threshold value will be exceeded and the monitoring system of the crane will be activated in order to stop the movement/function of the machine and forward a signal to the actuator to momentarily display a symbol indicating a stop 47 of the movement/function in the displaying section 27. The actuator may further be arranged to, if required, display status information from the monitoring system of the machine in any of the displaying sections regarding other machine functions than the current function controlled by means of a specific control member. The latter implies that not only warning triangle symbols 46 or stop symbols 47 will be displayed on the displaying section 27 in case of a movement/function regarding the current horizontal 46 control of the crane by means of the fourth control member 6 when a specific threshold values are exceeded and the monitoring system of the crane is activated. Instead, the control of other crane functions will be influenced and limited, as well, when the crane is displaced horizontally 36 by a specific distance. For example, the monitoring system of the crane may activate a stop 44 of the crane movement/function regarding the vertical displacement of the crane in a lower part 32, as displayed in the middle displaying section 25 of the first functional group 16, notwithstanding that no control is performed by the other control member 4.

FIG. 1D shows various functional groups 16-20 and other information, such as status information 21, that may be appear on the third, centrally positioned electro-optical displaying means 14. In that respect, other functional groups of the actuator can be selected, which are indicated by the symbols “2 Menu”, “3 Menu” or “4 Menu”, for the control of additional, other functions of the crane than the one's described with reference to FIG. 1A-B. On the third, centrally located electro-optical screen 14, a functional state “on/off Menu”20 may appear, as well as a functional state indicating information 21 regarding status, e.g. load, pressure, errors, angle, or the like. Thus, in the “on-off Menu” 20, the control members control other functions than the crane functions, such as start and stop of the machine, the lightning on/off, the regulation of the revolutions on/off, etc.

FIG. 1E shows symbols on the electro-optical screens relating to a second functional group 17, “2 Menu”. In that respect, the symbol on the left displaying section 24 of the first electro-optical screen 12, connected to the first control member 3, indicates that a vertical displacement between two crane members 48 is connected to be controlled by means of a first control member 3. The second control member 4 is connected for a horizontal, left displacement of two crane members 50 in this second functional group 17, as displayed with symbols on the middle displaying section 25 of the first electro-optical screen 12. The third displaying section 26 is empty and no function is connected for the third control member 5 regarding this second functional group 17, and, likewise, the left displaying section 27 for the second electro-optical screen 13 is empty, since no function is connected for the fourth control member 6, either. The fifth and the sixth control members, 7, 8 are connected for additional other crane movements 52, 54, as indicated by the symbols in the middle 28 displaying section and the right displaying section 29 on the second electro-optical screen 13.

As is apparent from FIG. 1B-1E, the electro-optical screens 12, 13 indicate the work operation achieved by a control performed by the control members. In other words, this is information from the crane to the actuator and to the operator, whereby the operator is able to view directly on a screen the event caused by the activation of a specific control member. The control system is configured in advance, to e.g. indicate a forward movement by an arrow in a specific direction on the screen/display, while an arrow in the opposite direction indicates a backward movement of the control member. This information can be displayed on the displaying sections of the screens, for example using arrow symbols, other types of symbols, a colour or the like.

By means of an actuator according to the present invention, it is easy to configure other symbols to indicate a function of interest on the screen/displaying section regarding a specific control member.

An actuator 2 according to the present invention is not limited to the control of hydraulic units, but may be used e.g. in connection with pneumatic units. Also, an actuator 2 is not limited to the control of cranes, but may be used for operating various types of machines and machine units, such as e.g. an overhead crane, an industrial robot or an automatic lathe, etc.

The present invention also relates to a computer program product provided with a programming code comprising commands for an actuator 2, s described above. The computer program product comprises information regarding the functions and the associated control members of said functional groups, an it is designed to perform the following steps, when executed on a computer: Reception of a control signal from functional group selecting means 29 of a selected functional group; collection of information regarding the functions and the corresponding control members of the selected functional group, and display of these functions on the function displaying means 12, 13 on the displaying sections 24-29 of each control member, according to the collected information.

1. An actuator for controlling and supervising machine functions, comprising two or more manual control members for the control of different functions, a function displaying means connected to each control member for indicating a selected function, characterized in that each of said manual control members is arranged to control one or more functions included in separate functional groups, each functional group comprising not more than one function per control member, wherein a desired functional group is selectable by means of functional group selecting means, said function displaying means comprising one or more electro-optical screens divided into one or more displaying sections, wherein each displaying section is connected to a specific control member and has a logical location relative this control member, and is arranged to indicate with a symbol and/or text the function controlled by this control member, and to display status information regarding machine functions recorded by the monitoring system of the machine when control is performed by this control member.

2. An actuator according to claim 1, characterized in that said electro-optical screens consist of LCD-screens.

3. An actuator according to claim 1, characterized in that it is also provided with electro-optical displaying means for momentary or continuous display of a selected functional group and/or of status information.

4. An actuator according to claim 3, characterized in that said manual control members are designed as a row of levers arranged to be moved forwards and backwards in one direction for the control of a function.

5. An actuator according to claim 4, characterized in that said electro-optical screens are arranged on a surface of an actuator, which surface is positioned substantially in parallel with the row of levers.

6. An actuator according to claim 1, characterized in that the displaying section for a specific control member is positioned substantially aligned with the forward and backward movement of the control member.

7. An actuator according to claim 1, characterized in that the control of a work operation achieved by influencing a specific control member in a specific direction is indicated on the electro-optical screen connected to this control member.

8. An actuator according to claim 7, characterized in that the work operation is indicated by the display of an arrow symbol directed in a specific direction when the control member is influenced in one direction, while the indication by an arrow symbol is directed in the opposite direction when the control member is influenced in an opposite direction.

9. An actuator according to claim 3, characterized in that the electro-optical displaying means is arranged to display status information, including load, pressure, error code or an alarm.

10. An actuator according to claim 1, characterized in that each displaying section, respectively, is arranged to, when required, momentarily display status information regarding machine functions recorded by the monitoring system of the machine, instead of a displayed symbol/text relating to the function controlled by a specific control member.

11. An actuator according to claim 10, characterized in that the actuator is adapted to, when required, display status information from the monitoring system of the machine in any of the displaying sections, also regarding other machine functions than the current function controlled by a specific control member.

12. Computer program product provided with a programming code comprising commands for an actuator according to claim 1, characterized in that the computer program product comprises information regarding the functions and of the associated control member corresponding to said functional groups, and is arranged to, upon execution on a computer, perform the following step:
reception of a control signal corresponding to a selected functional group,
collection of information regarding the functions and of the associated control member corresponding to the selected functional group, and
display of these functions on the function displaying means in the displaying sections corresponding to each control member, respectively, according to the collected information.
